(19) United States
(12) Patent Application Publication
(10) Pub. No.: US 2009/0168026 A1
(43) Pub. Date: Jul. 2, 2009

(54) FRONT PROJECTION SCREEN, A METHOD OF CONSTRUCTING THE SAME AND A FRONT PROJECTION SYSTEM INCLUDING THE SAME

(75) Inventor: Gang Chen, Basking Ridge, NJ (US)

Correspondence Address: HITT GAINES, PC;ALCATEL-LUCENT, PO BOX 832570, RICHARDSON, TX, 75083, US

(73) Assignee: Lucent Technologies Inc., Murray Hill, NJ (US)

(21) Appl. No.: 11/966,977

(22) Filed: Dec. 28, 2007

(51) Int. Cl. G03B 21/14

(52) U.S. Cl. 353/20; 353/84

(57) ABSTRACT

An apparatus, a method of fabricating a front projection screen and a front projection system is provided. In one embodiment, the apparatus includes a front projection screen including an image surface and a selective transmission layer fixed to and covering the surface. The surface is configured to diffusely reflect light incident thereon and the selective transmission layer is configured to allow projected light from a laser source to illuminate the surface and block ambient light incident thereon. The laser projected light has a wavelength within a designated bandwidth.

### TECHNICAL FIELD OF THE INVENTION

The present invention is directed, in general, to front projection systems and, more specifically, to improving contrast of laser projected images in front projection systems.

### BACKGROUND OF THE INVENTION

Different technologies are currently being used for the display of still images (e.g., pictures) or moving images (e.g., videos), hereinafter commonly referred to as images, in rear and front projection systems. In rear projection systems, the projector is on the opposite side of the screen from a viewer. In front projection systems, the viewer and the projector are on the same side of the screen. Front projection systems may be installed at fixed locations, for example, in homes or meeting rooms. Front projections systems may also include a portable front projector and front projection screen that can be moved between different meeting rooms or to other locations. Cathode ray tube (CRT) and Digital Light Processing (DLP) based projectors are examples of the front projectors that are currently being used in front projection systems.

Instead of transmitting and scattering images to a viewer through a screen as in rear projection systems, front projection screens reflect and scatter the images projected thereon back to the viewer. As such, front projections systems present many different optical and arrangement challenges not present in rear projection systems.

Accordingly, what is needed in the art are improvements for front projection systems.

### SUMMARY OF THE INVENTION

To address the above-discussed deficiencies of the prior art, the present invention provides an apparatus, a method of fabricating a front projection screen and a front projection system. In one embodiment, the apparatus includes a front projection screen including an image surface and a selective transmission layer fixed to and covering the surface. The surface is configured to diffusely reflect light incident thereon and the selective transmission layer is configured to allow projected light from a laser source to illuminate the surface and substantially block ambient light incident thereon. The laser projected light has a wavelength within a designated bandwidth.

In another aspect, the present invention provides the method of constructing a front projection screen. In one embodiment, the method includes: (1) obtaining an image surface configured to diffusely reflect light incident thereon and (2) attaching a selective transmission layer to the surface, wherein the selective transmission layer is configured to allow projected light from a laser source to illuminate the surface and to substantially block ambient light incident thereon, the projected light having a wavelength within a designated bandwidth

In yet another aspect, the present invention provides the front projection system. In one embodiment, the front projection system includes: (1) a laser projector configured to project red, blue and green laser light to represent images and (2) a front projection screen. The screen has an image surface configured to diffusely reflect light incident thereon including the red, blue and green light projected from the laser projector and has a selective transmission layer coupled to the surface. The selective transmission layer is configured to allow the projected red, blue and green light to illuminate the surface and to substantially block ambient light incident thereon.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1A illustrates a system diagram of an embodiment of a front projection system including a front projection screen constructed according to the principles of the present invention;

FIG. 1B illustrates a diagram of an embodiment of a selective transmission layer physically coupled to a surface according to the principles of the present invention;

FIG. 2 illustrates a graph representing the properties of an embodiment of a selective transmission layer used according to the principles of the present invention;

FIG. 3 illustrates a flow diagram of a method of constructing a front projection screen carried out according to the principles of the present invention.

### DETAILED DESCRIPTION

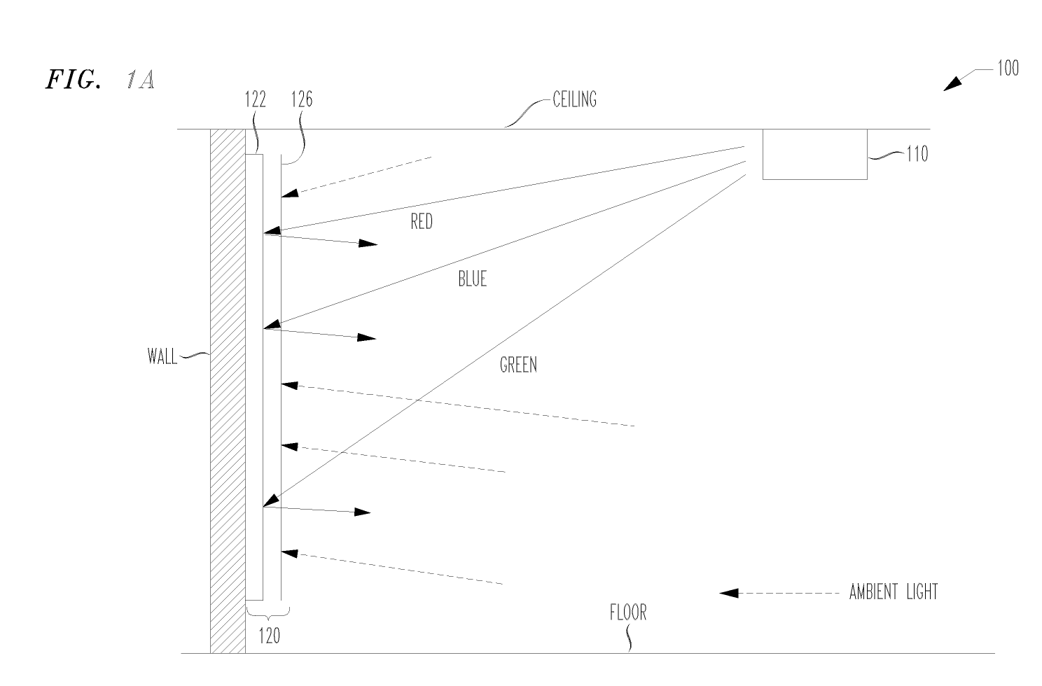

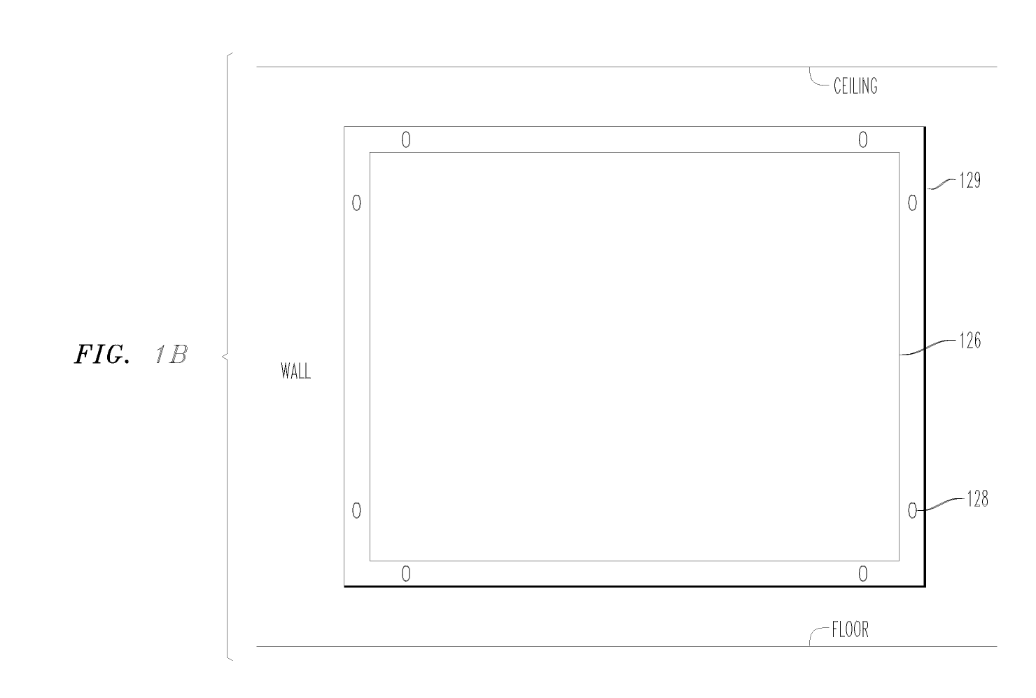

Referring initially to FIG. 1A, illustrated is a system diagram of an embodiment of a front projection system 100 located in a room represented by a ceiling, a floor and a wall. The front projection system 100 is used to present images to viewers by reflecting projected images to the viewers. The front projection system 100 includes a laser projector 110 and a front projection screen 120 constructed according to the principles of the present invention.

The front projection system 100 illustrates a fixed installation with the laser projector 110 mounted on the ceiling and the front projection screen 120, e.g., attached to the wall. One skilled in the art will understand that the laser projector 110 or the front projection screen 120 may be portable apparatuses instead of installed at a particular location.

The laser projector 120 may be a conventional laser projector configured to present colored images to viewers by projecting, e.g., red, blue and green light on a front projection screen. As such, the laser projector 120 includes three laser sources at different wavelengths. The laser sources may include, e.g., a first laser that projects red light, a second laser that projects blue light and a third laser that projects green light. Inherently, the light projected by each laser source has a narrow bandwidth (e.g., less than one nanometer) and a known center wavelength (e.g., for red, blue or green light). The laser projector 110 may project red light at a wavelength of about 630 nm (approximately any number between 610 and 650), blue light at a wavelength of or about 475 (approximately any number between 420 and 480) nm and green light at a wavelength of or about 510 (approximately any number between 510 and 540) nm. More information on the operation and configuration of front projection systems using a laser projector can be found in U.S. patent application Ser. No. 11/713,155, filed on Mar. 2, 2007, by Vladimir Aksyuk et al., and U.S. patent application Ser. No. 11/765,155 filed of Jun. 19, 2007, by Roland Ryf. Both of these applications are incorporated herein by reference in their entirety.

The front projection screen 120 is constructed to reflect images that are projected thereon. As with conventional front projection screens, the front projection screen 120 may be a fixed or portable apparatus. For example, the front projection screen 120 can be a fixed apparatus that is attached to the wall as illustrated in FIG. 1A or be free-standing with a base for support. The front projection screen 120 may also be retractable. In other words, the front projection screen 120 can be pulled-down for viewing and then rolled-up after viewing. The front projection screen 120 may also be a portable apparatus that can be collapsed and transported between locations.

The front projection screen 120 includes a surface 122 and a selective transmission layer 126. The surface 122 is a conventional surface used to diffusely reflect and/or scatter light incident thereon and can be a conventional diffusely reflecting surface used in front projection systems. In some embodiments, the surface 122 can be the wall, a coating applied to the wall or may be attached to the wall as illustrated in FIG. 1A. The surface 122 may be a white surface. In other embodiments, the surface 122 may be a gray surface.

The selective transmission layer 126 is placed in front of the surface 122 and is configured to selectively allow projected light from the laser projector 120 to illuminate the surface 122. In particular, the selective transmission layer 126 is configured to prevent ambient light from illuminating the surface 122. Ambient light may cause a high background to the images projected on a conventional front projection screen. In general, ambient light is light that is not projected unto the front projection screen from the laser projector 110. More specifically, ambient light has a large diversity of polarizations and a bandwidth that is much larger than the bandwidths of the laser sources. As a result, the contrast of the projected images may be reduced in a front projection system. The selective transmission layer 126, therefore, is configured to reduce the amount of ambient light to reach the surface 122. As such, the light reflected by the surface 122 is essentially the projected light from the laser projector 110. Accordingly, the contrast of the projected light from the laser projector 120 that is reflected to a viewer is improved over that in systems without the selective transmission layer 126.

The selective transmission layer 126 can be physically coupled to the surface 122 through various conventional chemical or mechanical means. The selective transmission layer 126 may be laminated on the front of the surface 122 or applied as a coating. Additionally, the selective transmission layer 126 may be coupled to the surface 122 using mechanical fixtures such as screws and/or a frame. FIG. 1B illustrates one embodiment of coupling the selective transmission layer 126 to the surface 122 (not identified in FIG. 1B) using screws 128 and a frame 129.

The selective transmission layer 126 can be added to the surface 122 post-manufacturing by an end-user or may be coupled to the surface 122 during manufacturing. Of course, one skilled in the art will understand that other methods of placing the selective transmission layer 126 in front of the surface 122 can be used.

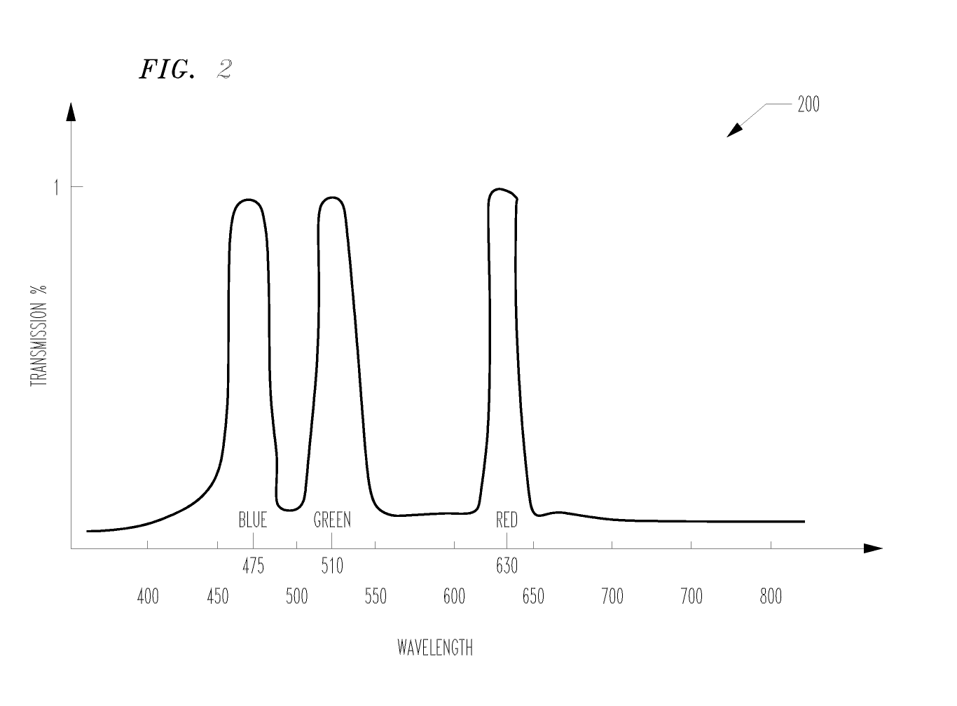

Since the wavelength of light projected by each of the lasers is narrow (e.g., less than one nanometer) and known (e.g., red, blue or green), then the selective transmission layer 126 is “tuned” with the laser projector 120 to selectively allow light from the laser projector 120 to pass therethrough to the surface 122. The selective transmission layer 126, therefore, may perform as a passband filter for the projected light from the laser projector 120. The selective transmission layer 126, therefore, is designed and manufactured to allow the laser projected light to pass through to the surface 122. FIG. 2 represents the properties of an embodiment of a selective transmission layer 126.

The selective transmission layer 126 may be an interference filter having three narrow passbands that encompass each of the wavelengths of the red, blue and green light projected by the laser projector 110. The interference filter, for example, may have three passbands with a first one of the three passbands encompassing the 475 nm wavelength of the projected blue light, a second one encompassing the 510 nm wavelength of projected green light and a third one encompassing the 630 nm wavelength of projected red light. Light having a wavelength that is not in one of the passbands will be reflected by the interference filter. Essentially all ambient light, which ranges in wavelengths between approximately 400 nanometers to 650 nanometers, outside of these passbands would therefore be reflected and not illuminate the surface 122.

Eyewear, such as glasses or goggles, having a layer of the interference filter may be used by a viewer to further enhance the image projected from the laser projector 110. The enhanced eyewear can shield ambient light from the viewer and reduce the reflection of the ambient light from the interference filter of the selective transmission layer 126. The eyewear with the interference filter will allow the red, blue and green laser lights to reach the viewer's eyes and reduce (e.g., block) the reception of ambient light to the viewer. The enhanced eyewear may include a selective transmission layer 126 as used with the front projection screen 120. Thus, the enhanced eyewear may also include a polarizing layer as discussed below. The interference filter and/or polarizing layer may be physically coupled to lens of the enhanced eyewear through a conventional means.

Due to the narrow bandwidth of the laser projected light, each of the passbands may have a small bandwidth, such as a full-width-at-half-maximum intensity bandwidth of three nanometers or less. Indeed, the bandwidth of each of the passbands can even be much larger and still remove a substantial portion of the background or ambient light. For example, the passbands could be 20 nanometers or less and still reduce the intensity of white background light by about 50% (reduction of 50%). The width of passbands may be determined by multiplying the desired percentage of reduction by 0.4. Thus, for a reduction of about 33.33%, passbands of 13.33 nanometers or less could be used. Additionally, passbands of 10 nanometers or less could be used to provide a reduction of about 10%.

The interference filter can be made flexible and can be integrated with the surface 122 or closely attached to the front of the surface 122. The front of the front projection screens is the side of the projection screens that receives light projected from the laser projector 110. FIG. 2 illustrates properties of an exemplary passband filter that can be used as the selective transmission layer 126.

In other embodiments, the selective transmission layer 126 may be a linearly polarizing filter. A linear polarizer filter transmits one of two states of linearly polarized light. Since light projected from the laser projector 120 is linearly polarized in a known state (e.g., red, blue and green light produced with the same linear polarization), a linear polarizing filter can be configured to allow light polarized in the known state to pass through the selective transmission layer 126 (i.e., transmits the projected laser light) and onto the surface 122. The known state may be vertically or horizontally polarized, i.e., for all laser color sources. The ambient light is unpolarized and half of it, therefore, will not illuminate the surface 122. Thus, the contrast of the projected images can be improved by a factor of two by such a filter provided that all laser sources have substantially parallel polarizations along the transmission polarization axis of the polarization filter in the selective transmission layer 126. The linear polarizing layer may be a thin film linear polarizer attached to the surface 122. One skilled in the art will understand how to make and attach such a linear polarizing filter to a surface.

A linear polarizing layer, therefore, can be used as the selective transmission layer 126 or as part of the selective transmission layer 126. In some embodiments, the selective transmission layer 126 may include multiple layers that include an interference filter and a linear polarizing filter. In some embodiments, a layer including the interference filter may be the first layer next to the front side of the surface 122. In other embodiments, a layer including the linear polarizing filter may be the first layer next to the front side of the surface 122.

Since the wavelength(s) of the projected light from the laser projector 120 is known and the bandwidth is narrow, the selective transmission layer 126 is manufactured to allow light at these selected wavelengths to pass through to the surface 122. Additionally, the selective transmission layer 126 is configured to attenuate ambient light from illuminating the surface 122. Thus, the selective transmission layer 126 is manufactured to prevent most of the light that is not projected from the laser projector 120 from passing through to the surface 122. Accordingly, the contrast of the images that are projected onto the surface and reflected from the surface 122 is increased.

FIG. 2 illustrates a graph representing the properties of an embodiment of a selective transmission layer, such as from FIG. 1A, used according to the principles of the present invention. The present invention recognizes a laser projector uses narrow bands of lasers as the light source for forming the projected images. Employing a selective transmission layer on a front projection screen allows the transmission of projected laser light having the narrow bandwidths while also reducing the transmission of ambient light to illuminate the screen. The contrast of the projected image can therefore be enhanced. Employing a selective transmission layer is not effective, however, with projectors that do not project light at narrow wavelengths, such as projectors using illumination sources such as broadband lamps and LEDs. As one skilled in the art will understand, an interference filter for designated wavelengths also refers to an interference filter of designated frequencies since frequencies is defined as the number of times a wavelength passes a designated point.

The graph of FIG. 2 represents an interference filter which has three narrow transmission bands that encompass the wavelengths of red, green and blue light projected from a laser projector. Along the x-axis are the wavelengths in nanometers. The y-axis represents the intensity of the interference filter at the different wavelengths. Each of the passbands encompassing the red, blue and green light has an intensity full-width-at-half-maximum of approximately three nanometers or less. Light having a wavelength outside of the transmission bands is attenuated and substantially prevented from illuminating the surface of a front projection screen.

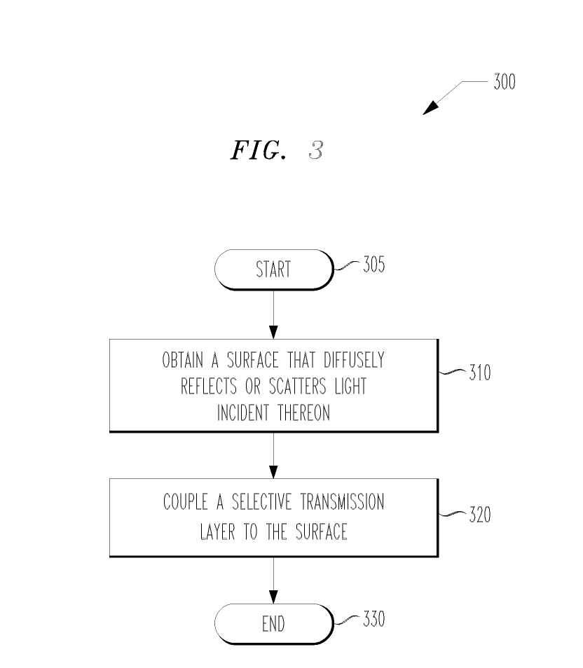

FIG. 3 illustrates a flow diagram of a method 300 of constructing a front projection screen carried out according to the principles of the present invention. The front projection screen is constructed to improve contrast of projected images from a laser front projector. The method 300 begins in a step 305 with the intent to construct the front projection screen.

After starting, a surface to diffusely reflect light incident thereon is obtained in a step 310. The surface may be an existing surface or may be fabricated specifically for constructing a front projection screen according to the present invention. The surface may be a conventional surface used for front projection screens and can be manufactured employing a typical process understood by one skilled in the art. For example, the surface may be a highly reflective, opaque material.

After obtaining the surface, a selective transmission layer is fabricated in a step 315. The selective transmission layer may be fabricated as a dielectric coating having the desired passbands associated with the red, blue and green light projected from a laser source. Edmund Optics Inc., of Barrington, N.J., for example, may manufacture the selective transmission layer 126 as a coating having the passband properties illustrated in FIG. 2. Additionally, a coating including a linear polarizing filter may be included with the passband filter to comprise the selective transmission layer. Information regarding Edmund Optics Inc. can be found on their website.

After fabricating the selective transmission layer, a selective transmission layer is physically coupled to the surface in a step 320. The selective transmission layer may be physically coupled to the surface by laminating the selective transmission layer to the surface. In some embodiments, the selective transmission layer can be attached to the surface via a mechanical fixture. A frame can be attached around the outer edges of the selective transmission layer to secure the layer against the surface. Additionally, the selective transmission layer may be a coating that is applied to the surface. The selective transmission layer can be applied during manufacturing of the front projection screen or may be added post-manufacturing.

The selective transmission layer is configured to allow projected light from a laser projector to illuminate the surface and to substantially attenuate ambient light from illuminating the surface. Since the wavelength of light projected by the laser projector is known and within narrow bandwidths, the selective transmission layer is designed and constructed to allow transmission of the projected light. The selective transmission layer, therefore, allows a front projection screen to back scatter specific wavelengths of light within three specified narrow wavelength ranges, i.e., ranges of the laser sources. With the selective transmission layer placed in front of the surface, the contrast of images projected onto the surface from the laser projector is increased since light outside of the designated narrow ranges is prevented (e.g., reflected) from passing through to the surface. A viewer can use eyewear having an interference filter that allows the red, blue and green laser lights projected by the laser projector to reach the viewer's eyes and reduce (e.g., block) the reception of ambient light to the viewer. The enhanced eyewear may include a selective transmission layer as used with the front projection screen.

Since the projected light from the laser projector includes light projected from multiple lasers, the selective transmission layer is designed and constructed to allow transmission of the projected light from each of the lasers. Thus, the selective transmission layer allows transmission of multiple known wavelengths to illuminate the surface. Of course, one skilled in the art will understand that the selective transmission layer can be designed to allow transmission of designated wavelengths of laser light and laser projectors can then be chosen accordingly. Typically, the known wavelengths or wavelength ranges of laser light correspond to red light, blue light and green light.

In one embodiment, the selective transmission layer includes an interference filter that allows transmission of the projected red, blue and green light but reflects other light incident thereon. In other embodiments, the selective transmission layer may include a linear polarizing filter. In some embodiments, the linear polarizing filter may be in addition to the interference filter. After attaching the selective transmission layer to the surface, the method 300 ends in a step 330.

Although the present invention has been described in detail, those skilled in the art should understand that they can make various changes, substitutions and alterations herein without departing from the spirit and scope of the invention in its broadest form.

What is claimed is:

1. An apparatus, comprising:
a front projection screen including an image surface and a selective transmission layer fixed to and covering said surface; and
wherein said surface is configured to diffusely reflect light incident thereon and said selective transmission layer is configured to allow projected light having a designated bandwidth from a laser source to illuminate said surface and substantially block ambient light incident thereon.

2. The apparatus as recited in claim 1 wherein said projected light includes light in multiple disjoint wavelength ranges and said selective transmission layer is configured to allow light in those ranges to illuminate said surface.

3. The apparatus as recited in claim 2 wherein said ranges encompass wavelengths of light selected from the group consisting of:
red light,
blue light, and
green light.

4. The apparatus as recited in claim 2 wherein said selective transmission layer includes an interference filter configured to reflect light that does not have a wavelength within one of said ranges.

5. The apparatus as recited in claim 2 wherein each of said ranges has a full-width-at-half-maximum of approximately three nanometers for transmitted intensities.

6. The apparatus as recited in claim 2 wherein said selective transmission layer includes a linear polarizing filter.

7. The apparatus as recited in claim 1 wherein said selective transmission layer includes an interference filter and a linear polarizing filter.

8. A method of constructing a front projection screen, comprising:
obtaining an image surface configured to diffusely reflect light incident thereon; and
attaching a selective transmission layer to said surface, said selective transmission layer configured to allow projected light from a laser source to illuminate said surface and substantially block ambient light incident thereon, said projected light having a designated bandwidth.

9. The method as recited in claim 8 wherein said selective transmission layer allows light projected from a plurality of disjoint color ranges to illuminate said surface.

10. The method as recited in claim 9 wherein said color ranges includes red, blue, and green.

11. The method as recited in claim 8 wherein said selective transmission layer includes an interference filter configured to reflect ambient light.

12. The method as recited in claim 11 wherein said interference filter has three disjoint passbands having full-widths-at-half-maximum intensity three nanometers or less.

13. The method as recited in claim 8 wherein said selective transmission layer includes a linear polarizing filter.

14. The method as recited in claim 8 wherein said selective transmission layer includes an interference filter and a linear polarizing filter.

15. A front projection system, comprising:
a laser projector configured to project red, blue and green laser light to represent images; and
a front projection screen, including:
an image surface configured to diffusely reflect light incident thereon including said red, blue and green light projected from said laser projector; and
a selective transmission layer coupled to said surface and configured to allow said projected red, blue and green light to illuminate said surface and to substantially block ambient light incident thereon.

16. A front projection system as recited in claim 15 wherein said selective transmission layer includes an interference filter configured to reflect light that is not said projected light.

17. The front projection system as recited in claim 15 wherein said selective transmission layer includes a linear polarizing filter.

18. The front projection system as recited in claim 17 wherein said linear polarizing filter transmits light polarized in a same state as said laser projected light.

19. The front projection system as recited in claim 15 wherein said selective transmission layer includes an interference filter and a linear polarizing filter.

20. The front projection system as recited in claim 15 wherein said interference filter has three disjoint passbands having full-width-at-half-maximum intensity bandwidths of three nanometers or less.
